(19) United States
(12) Patent Application Publication
(10) Pub. No.: US 2009/0017335 A1
(43) Pub. Date: Jan. 15, 2009

(54) POLYCRYSTALLINE SILICON SUBSTRATE FOR MAGNETIC RECORDING MEDIA, AND MAGNETIC RECORDING MEDIUM

(75) Inventor: Yasushi TAKAI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 12/139,725

(22) Filed: Jun. 16, 2008

(30) Foreign Application Priority Data
Jul. 10, 2007 (JP) 2007-180436

(51) Int. Cl. G11B 5/62

(52) U.S. Cl. 428/846.2; 428/336; 428/846.1

(57) ABSTRACT

The proportion of {100} crystal faces, the polish rate of which is relatively high during crystal machining, and/or the proportion of {111} crystal faces, the polish rate of which is relatively low during crystal machining, to the total area (S₀) of a substrate surface, is set to fall within an appropriate range. Specifically, the proportion of the total area (S_{{100}}) of the {100} crystal faces among crystal faces of individual crystal grains which appear on a major surface of a polycrystalline silicon substrate to the total area (S₀) of the substrate surface, is set not less than 10% and less than 50%. Such crystal face selection makes it possible to reduce the scale of “steps” formed due to the crystal face index dependence of polish rate, thereby to give a planar and smooth substrate surface.

### BACKGROUND OF THE INVENTION

1. Field of the Invention

The present invention relates to a silicon substrate for use in fabricating a magnetic recording medium for hard disk drives and the like.

2. Description of the Related Art

In the technical field of information recording, a hard disk device as means for magnetically reading/writing such information as letters, images, or music is now indispensable as a primary external recording device or built-in type recording means for use with or in electronic devices including a personal computer. Such a hard disk device incorporates therein a hard disk as a magnetic recording medium. Conventional hard disks have employed a so-called “in-plane magnetic recording system (i.e., longitudinal magnetic recording system)” which writes magnetic information on a disk surface longitudinally.

FIG. 1A is a schematic sectional view illustrating a typical stacked layer structure for a hard disk of the longitudinal magnetic recording system. This structure includes a Cr-based underlayer 2 formed by sputtering, a magnetic recording layer 3, and a carbon layer 4 as a protective film, which are sequentially stacked on a non-magnetic substrate 1, and a liquid lubricating layer 5 formed by applying a liquid lubricant to a surface of the carbon layer 4 (see Japanese Patent Laid-Open No. 5-143972 (Patent Document 1) for example). The magnetic recording layer 3 comprises a uniaxial magnetocrystalline anisotropic Co alloy, such as CoCr, CoCrTa, or CoCrPt. Crystal grains of the Co alloy are magnetized in a longitudinal direction of a disk surface to record information. The arrows in the magnetic recording layer 3 shown indicate directions of magnetization.

With such a longitudinal magnetic recording system, however, when individual recording bits are reduced in size to increase the recording density, the north pole and south pole of a recording bit repel the north pole and south pole, respectively, of an adjacent recording bit, to make the boundary region magnetically unclear. For this reason, the thickness of the magnetic recording layer needs to be decreased to reduce the crystal grain size for the purpose of realizing recording density growth. As crystal grains are made more minute (i.e., reduced in volume) and recording bits made smaller in size, it is pointed out that a phenomenon called “heat fluctuation” occurs to disorder magnetization directions of crystal grains by thermal energy, thereby to cause a loss of recorded data. Thus, the recording density growth has been considered to be limited. The effect of the heat fluctuation becomes serious when the KᵤV/k_{B}T ratio is too low. Here, Kᵤ represents magnetocrystalline anisotropic energy of a recording layer, V represents the volume of a recording bit, k_{B} represents a Boltzmann constant, and T represents an absolute temperature (K).

In view of such a problem, a “perpendicular magnetic recording system” is now studied. With this recording system, the magnetic recording layer is magnetized perpendicularly to the disk surface, so that north poles and south poles are alternately arranged as bound one with the other in recording bits. Therefore, a north pole and a south pole in a magnetic domain are positioned adjacent to each other, to strengthen mutual magnetization. As a result, the magnetized state (i.e., magnetic recording) is highly stabilized. When a magnetization direction is recorded perpendicularly, a demagnetizing field of a recording bit is weakened. For this reason, the perpendicular magnetic recording system does not need to make the recording layer very thin, as compared with the longitudinal magnetic recording system. Accordingly, if the recording layer is thickened to ensure a larger perpendicular direction, the recording layer, as a whole, has an increased KᵤV/k_{B}T ratio, thereby making it possible to reduce the effect of the “heat fluctuation”.

Since the perpendicular magnetic recording system is capable of weakening the demagnetizing field and ensuring a KᵤV value as described above, the perpendicular magnetic recording system can lower the instability of magnetization due to the “heat fluctuation”, thereby making it possible to expand a margin of recording density substantially. Therefore, the perpendicular magnetic recording system is expected to realize ultrahigh density recording.

FIG. 1B is a schematic sectional view illustrating a basic layer structure for a hard disk as a “double-layered perpendicular magnetic recording medium” having a recording layer for perpendicular magnetic recording which is stacked on a soft magnetic backing layer. This structure includes a soft magnetic backing layer 12, a magnetic recording layer 13, a protective layer 14, and a lubricating layer 15, which are sequentially stacked on a non-magnetic substrate 11. Here, the soft magnetic backing layer 12 typically comprises permalloy, amorphous CoZtTa, or a like material. The magnetic recording layer 13 comprises a CoCrPt-based alloy, a CoPt-based alloy, a multi-layered film formed by alternately stacking several layers including a PtCo layer and ultrathin films of Pd and Co, an amorphous PtFe or SmCo film, or the like. The arrows in the magnetic recording layer 13 shown indicate directions of magnetization.

The hard disk of the perpendicular magnetic recording system includes the soft magnetic backing layer 12 underlying the magnetic recording layer 13, as shown in FIG. 1B. The soft magnetic backing layer 12, which has a magnetic property called “soft magnetic property”, has a thickness of about 100 nm to 200 nm. The soft magnetic backing layer 12 is provided for enhancing the writing magnetic field and weakening the demagnetizing field of the magnetic recording film and functions as a path which allows a magnetic flux to pass therethrough from the magnetic recording layer 13 and as a path which allows a magnetic flux for writing to pass therethrough from a recording head. That is, the soft magnetic backing layer 12 functions like an iron yoke provided in a permanent-magnet magnetic circuit. For this reason, the soft magnetic backing layer 12 has to be set thicker than the magnetic recording layer 13 for the purpose of avoiding magnetic saturation during writing.

Hard disks of the longitudinal magnetic recording system as shown in FIG. 1A are gradually switching to hard disks of the perpendicular magnetic recording system as shown in FIG. 1B as the recording density increases from a border which ranges from 100 to 150 Gbit/square inch because the longitudinal magnetic recording system has a recording limit due to the heat fluctuation and the like. Though the recording limit of the perpendicular magnetic recording system remains uncertain at present, the recording limit thereof is estimated to ensure a value of not less than 500 Gbit/square inch. In another view, the perpendicular magnetic recording system can achieve a recording density as high as about 1,000 Gbit/square inch. Such a high recording density can provide for a recording capacity of 600 to 700 Gbytes per 2.5-in. HDD platter.

Substrates generally used in magnetic recording media for HDDs include an Al alloy substrate used as a substrate having a diameter of 3.5 inches, and a glass substrate used as a substrate having a diameter of 2.5 inches. In mobile applications such as a notebook personal computer, in particular, HDDs frequently undergo impacts from outside. Therefore, a 2.5-in. HDD used in such a mobile application has a high possibility that its recording medium or substrate is damaged or data destroyed by “head-disk collision”. For this reason, use has been made of a glass substrate having a high hardness as a substrate for magnetic recording media.

As a mobile device is downsized, a substrate for use in a magnetic recording medium to be incorporated therein calls for a higher impact resistance. Substrates having small diameters of not more than 2 inches are mostly used in mobile applications and hence call for a higher impact resistance than 2.5-in. substrates. Also, the downsizing of such a mobile device inevitably calls for downsizing and thinning of parts to be used therein. A standard thickness of a substrate having a diameter of 2.5 inches is 0.635 mm, whereas that of a substrate having a diameter of, for example, 1 inch is 0.382 mm. Under such circumstances, a demand exists for a substrate which has a high Young's modulus, ensures a sufficient strength even when made thin, and offers good compatibility with a magnetic recording medium fabrication process.

Though a glass substrate having a diameter of 1 inch and a thickness of 0.382 mm has been put to practical use by mainly using reinforced amorphous glass, further thinning is not easy. Further, since a glass substrate is an insulator, a problem arises that the substrate is likely to be charged up during formation of a magnetic film by sputtering. Though volume production of such substrates is made practically possible by changing a holder holding a substrate to another one during sputtering, this problem is one of the factors that make the use of a glass substrate difficult.

Study has been made of FePt or the like as a material for a next-generation recording film. Such an FePt film needs to be heat-treated at a high temperature of about 600° C. so as to have a higher coercive force. Though studies have been made to lower the heat treatment temperature, a heat treatment at a temperature of not lower than 400° C. is still needed. Such a temperature exceeds the temperature at which currently used glass substrates can resist. Likewise, Al substrates cannot resist such a high temperature treatment.

Besides such glass substrate and Al substrate, alternative substrates have been proposed which include a sapphire glass substrate, SiC substrate, engineering plastic substrate, and carbon substrate. However, the realities are such that any one of such substrates is inadequate for use as an alternative substrate for a small-diameter substrate in view of its strength, processability, cost, surface smoothness, affinity for film formation, and like properties.

Under such circumstances, the inventors of the present invention have already proposed use of a single crystal silicon (Si) substrate as an HDD recording film substrate (see Japanese Patent Laid-Open No. 2005-108407 (Patent Document 2) for example).

Such a single crystal Si substrate, which is widely used as a substrate for LSI fabrication, is excellent in surface smoothness, environmental stability, reliability, and the like and has a higher rigidity than glass substrates. For this reason, the single crystal Si substrate is suitable for an HDD substrate. In addition, unlike glass substrates having insulating properties, the single crystal Si substrate is for use in semiconductor devices and generally has a certain electric conductivity because the single crystal Si substrate frequently contains a p- or n-type dopant. Thus, the single crystal Si substrate can lessen the charge up effect, which occurs during film formation by sputtering, to a certain extent and allows a metal film to be formed thereon by direct sputtering or bias sputtering. Further, since the single crystal Si substrate has good thermal conductivity, the Si crystal substrate can be easily heated and has very good compatibility with the sputtering process for film formation. What is more, the Si substrate has an advantage that its crystal purity is very high and its substrate surface obtained after processing is stable with a negligible change over time.

However, Si single crystals of the “semiconductor grade” for fabrication of such devices as LSIs are generally expensive. In fact, the price of Si single crystals of “the semiconductor grade” is soaring with increasing demand due to solar cells widespread in recent years. When consideration is given to the use of the single crystal Si substrate as a substrate for magnetic recording media, a serious problem arises that the single crystal Si substrate becomes inferior to glass substrates or Al substrates in terms of raw material cost as its diameter increases.

Use of a polycrystalline Si substrate is conceivable as one measure to reduce the cost. However, this measure gives rise to the following problem. That is, in the case of a recording medium (i.e., magnetic disk) of the perpendicular magnetic recording system with its recording density improved, the flying height of a magnetic head flying above the surface of the magnetic disk is lowered. In order to realize such a low flying height, substrates for magnetic recording media call for higher planarity and smoothness than ever. Polycrystalline silicon obtained by hydrogenation of chlorosilane has different crystal orientations crystal grain by crystal grain, which results in the polish rate or etching rate differing crystal grain by crystal grain. For this reason, it is difficult to obtain a smooth surface by CMP or the like.

### SUMMARY OF THE INVENTION

The present invention has been made in view of the foregoing problems. Accordingly, it is an object of the present invention to provide a polycrystalline Si substrate for magnetic recording media which has sufficient impact resistance and heat resistance, fails to complicate the fabrication process and the film formation process for a magnetic recording layer, exhibits such an excellent surface planarity as to allow a low flying height to be realized, and is inexpensive.

In order to solve the foregoing problems, a silicon substrate for magnetic recording media according to a first invention comprises a substrate surface, and {100} crystal faces included in the substrate surface, wherein a proportion of a total area (S_{{100}}) of the {100} crystal faces to a total area (S₀) of the substrate surface is not less than 10% and is less than 50%.

A polycrystalline silicon substrate for magnetic recording media according to a second invention comprises a substrate surface, and {111} crystal faces included in the substrate surface, wherein a proportion of a total area (S_{{111}}) of the {111} crystal faces to a total area (S₀) of the substrate surface is not less than 30% and not more than 90%.

Preferably, the polycrystalline silicon substrate for magnetic recording media according to the present invention includes an oxide film having a thickness of not less than 10 nm and not more than 2,000 nm and formed over the surface thereof. Preferably, the polycrystalline silicon substrate has a mean square waviness value and a mean square microwaviness value which are both not more than 0.3 nm.

Such a polycrystalline silicon substrate can be obtained by being cut out of an ingot grown by unidirectional solidification at a solidification rate of not less than 0.01 mm/min and not more than 1 mm/min.

By providing a magnetic recording layer on such a polycrystalline silicon substrate, a magnetic recording medium according to the present invention can be provided.

In the polycrystalline silicon substrate for magnetic recording media according to the present invention, the proportion of the {100} crystal faces, the polish rate of which is relatively high during crystal machining, and/or the proportion of the {111} crystal faces, the polish rate of which is relatively low during crystal machining, to the total area (S₀) of the substrate surface is set to fall within an appropriate range. With this arrangement, the scale of “steps” formed due to the crystal face index dependence of polish rate can be reduced, which makes it possible to give a planar and smooth substrate surface.

As a result of planarization and smoothing of the substrate surface, a magnetic recording medium fabricated using such a substrate allows a low flying height to be realized. Also, the properties of polycrystalline Si as the material can assure that the substrate has sufficient impact resistance and heat resistance and fails to complicate the fabrication process and the film formation process for a magnetic recording layer. Further, the polycrystalline Si substrate can be utilized as an inexpensive polycrystalline Si substrate for magnetic recording media.

### BRIEF DESCRIPTION OF THE DRAWINGS

FIG. 1A is a schematic sectional view illustrating a typical stacked layer structure for a hard disk of the longitudinal magnetic recording system;

FIG. 1B is a schematic sectional view illustrating a basic layer structure for a hard disk as a “double-layered perpendicular magnetic recording medium” having a recording layer for perpendicular magnetic recording which is stacked on a soft magnetic backing layer;

FIG. 2A is a schematic sectional view illustrating the scheme of an exemplary polycrystalline silicon ingot producing device in a state in which a crucible is charged with raw material according to the present invention;

FIG. 2B is a view illustrating a state in which an ingot is being grown; and

FIG. 3 is a flowchart illustrating an exemplary process for fabricating an Si substrate for magnetic recording media according to the present invention.

### DESCRIPTION OF THE PREFERRED EMBODIMENTS

Hereinafter, embodiments of the present invention will be described in detail with reference to the drawings.

### [Properties and Crystal Faces of Polycrystalline Silicon Substrate]

A polycrystalline silicon substrate for magnetic recording media according to the present invention need not have a purity of the so-called “semiconductor grade” (which generally has a purity of “11 nines” (99.999999999%) or higher). It is sufficient for the polycrystalline Si substrate to have a purity of substantially the “solar grade”. Though the purity of a polycrystalline Si of the solar grade is generally not less than “6 nines” (99.9999%), the present invention can tolerate a purity down to “3 nines” (99.9%). A purity of not less than “5 nines” (99.999%) is preferable.

The preferable value of purity of the polycrystalline Si is set to “5 nines” because a lower purity than the preferable value allows an impurity contained in the crystal to precipitate in grain boundaries, which might lower the strength of the substrate. Though polycrystalline Si having a higher purity is more preferable from the viewpoint of the substrate strength and the like, the raw material cost increases as the purity becomes higher. For this reason, the purity of polycrystalline Si is about “8 nines” (99.999999%) to about “9 nines” (99.9999999%) at the highest.

The concentrations of impurity metals which can react with Si to form silicides, such as alkali metals including Li, K, Na, and the like, and alkali earth metals including Ca, Mg, and the like, are desirably low. Specifically, the concentration of each of these impurity elements is not more than 1 ppm, preferably not more than 0.1 ppm. Likewise, the concentrations of transition metals, such as Fe, Ni, and Cu, which may cause the silicon substrate to be pierced in association with a reduction-oxidation potential during polishing, are desirably low. Specifically, the concentration of each of these impurity elements is not more than 1 ppm, preferably not more than 0.1 ppm.

The electrical resistance of the silicon substrate is preferably not less than 0.01 Ω/cm and not more than 100 Ω/cm, more preferably not less than 0.1 Ω/cm and not more than 50 Ω/cm, in terms of sheet resistivity. The value of resistance is determined from the amount of dopants, such as B, P, N, As, and Sn, contained in the silicon crystal. It is sufficient that the amount of dopants contained in the crystal is not more than about 10²² atoms/cm³ in terms of the sum total of the amounts of donor impurities and the amounts of acceptor impurities. When the amount of dopants contained in the crystal is too large, “resistance fringes” appear in the crystal, so that the surface of the substrate cannot be made smooth by polishing. On the other hand, when the amount of dopants is too small, the resistance of the crystal becomes high, which makes it difficult to pass a bias current during sputtering or a like step for formation of a magnetic film, thus resulting in problems including difficult film formation.

Since the polycrystalline silicon substrate is “polycrystalline”, various crystal faces appear on the substrate surface. The present invention establishes the following conditions for crystal faces of individual crystal grains which appear on the substrate surface in order to set the proportion of {100} crystal faces and/or the proportion of {111} crystal faces to the total area (S₀) of the substrate surface to fall within an appropriate range. The polish rate of the {100} crystal faces is relatively high during crystal machining, while the polish rate of the {111} crystal faces is relatively low during crystal machining. Here, the “{100} crystal face” means a crystal face equivalent to a {100} crystal face, and the “{111} crystal face” means a crystal face equivalent to a {111} crystal face.

The first condition is to set the proportion of the {100} crystal faces of which the polish rate is high to fall within an appropriate range, thereby to allow the substrate surface to be smoothed and planarized by polishing. Specifically, the proportion of the total area (S_{{100}}) of the {100} crystal faces among crystal faces of individual crystal grains which appear on the substrate surface of the polycrystalline silicon substrate to the total area (S₀) of the substrate surface is set not less than 10% and less than 50%. When the percentage of the {100} crystal faces is more than 50%, the smoothness and planarity of the silicon substrate surface are lowered noticeably by “steps” formed due to the difference in polish rate between the {100} faces of which the polish rate is high and the {111} faces of which the polish rate is low. The proportion (i.e., percentage) of a crystal orientation in a plane can be measured by pole figure analysis, EPMA-EBSP method, or a like method.

The second condition is to set the proportion of the {111} faces of which the polish rate is low to fall within an appropriate range, thereby to allow the substrate surface to be smoothed and planarized by polishing. Specifically, the proportion of the total area (S_{{111}}) of the {111} crystal faces among crystal faces of individual crystal grains which appear on the substrate surface of the polycrystalline silicon substrate to the total area (S₀) of the substrate surface is set not less than 30% and not more than 90%. When the percentage of the {111} crystal faces is less than 30% or more than 90%, the smoothness and planarity of the silicon substrate surface are lowered noticeably by “steps” formed due to the difference in polish rate between the {111} faces of which the polish rate is low and the {100} faces of which the polish rate is high.

The majority of faces which appear on the polycrystalline silicon substrate surface are low index faces, such as {110} faces and {112} faces, apart from the {100} faces and {111} faces.

### [Method of Growing Polycrystalline Silicon Ingot]

An ingot used in the present invention for fabricating the polycrystalline silicon substrate is grown by the following manner for example. In a melting furnace, metallic silicon as raw material is put into a crucible formed from a material which fails to react with silicon (for example, a quartz glass crucible, carbon crucible, silicon nitride crucible, or the like). The crucible is then held at a temperature of not lower than the melting point of silicon (about 1,420° C.) and not higher than 1,600° C. in an inert atmosphere (argon, nitrogen, or the like) or in a vacuum, to melt the metallic silicon. The silicon thus melted is unidirectionally solidified at a solidification rate of about 0.01 mm/min to 1 mm/min (preferably 0.05 mm/min to 0.8 mm/min).

When the solidification rate is less than 0.01 mm/min, the proportion of crystal faces ({112} faces and like faces) other than the {111} faces (and {100} faces) tends to increase, which makes it difficult to maintain appropriate crystal face percentages and, in addition, causes the crystal growth time to be lengthened, thus resulting in an increased production cost. On the other hand, when the solidification rate is more than 1 mm/min, the percentage of the {100} crystal faces increases, which is not preferable from the viewpoint of maintaining the appropriate crystal face percentages. In order to obtain desired polycrystalline silicon substrates stably, the unidirectional solidification rate is preferably set to fall within a range from 0.05 mm/min to 0.8 mm/min.

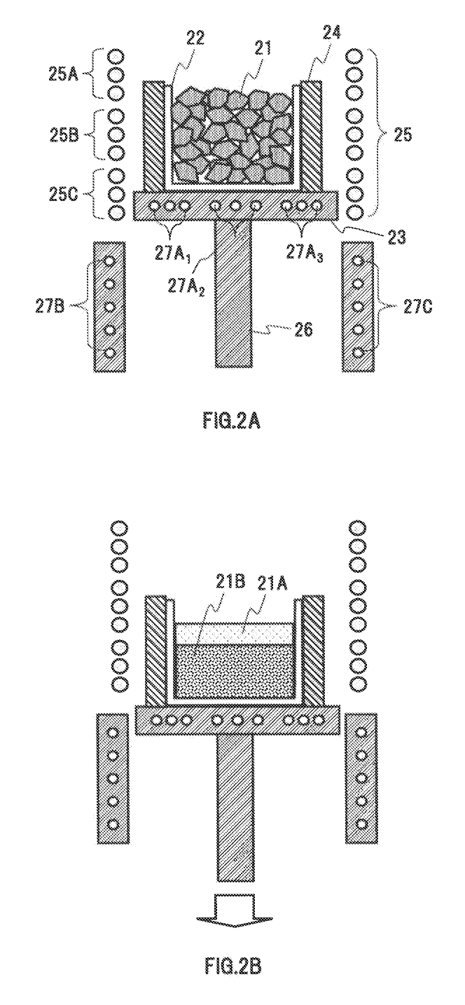

FIGS. 2A and 2B are each a schematic sectional view illustrating the scheme of an exemplary polycrystalline silicon ingot producing device used in the present invention; specifically, FIG. 2A illustrates a state in which a crucible is charged with raw material and FIG. 2B illustrates a state in which an ingot is being grown. A crucible 22 charged with metallic silicon 21 as the raw material is set on a seat 23. The metallic silicon 21 is melted in the crucible 22 covered with graphite material 24 by heating means such as an induction heating coil 25.

The induction heating coil 25 shown is divided into three zones (25A, 25B and 25C) which are capable of controlling the heating condition independently. Heating is controlled so that the heating temperature becomes higher as the crucible 22 extends toward its top. Reference numeral 26 designates a support of the seat 23, and reference character 27A to 27C designate water-cooling pipes for unidirectionally solidifying the silicon.

First, the metallic silicon 21 is melted at 1,600° C., which is higher by about 200° C. than the melting point of silicon, i.e., 1,420° C. and then held in that state for a fixed period of time so as to prevent the metallic silicon 21 from remaining unmelted. In order to concentrate impurities, which have been contained in the metallic silicon 21, at an upper portion of the silicon melt, a control is performed of the temperature of a portion of the silicon melt which is situated adjacent the interface between a molten phase (21A) and a solidified phase (21B) of silicon (i.e., solid-melt interface). Specifically, the control is performed so as to provide a stepwise temperature gradient within a range up to 1,600° C. (for example, 1,550° C. to 1,600° C.) in an upper portion of the crucible which extends upwardly from a height level at which the temperature of the crucible assumes 1,450° C.

The unidirectional solidification is started by passing cooling water through the cooling pipes 27A to 27C. At that time, the cooling water flow rate is regulated so that the temperature difference between a portion of the silicon melt in a central portion of the crucible 22 and a portion of the silicon melt in a peripheral portion of the crucible 22 is smaller than or equal to 50° C. to allow solidification of the silicon to proceed vertically. For this purpose, the cooling pipe 27A embedded in the seat 23 is divided into three segments (27A₁, 27A₂, and 27A₃). Thus, cooling conditions for respective of the central portion and peripheral portion of the crucible 22 are controlled independently. Under such a temperature control, the position of the crucible 22 is gradually lowered so that the solidification rate assumes 0.01 to 1.0 mm/min. In this way, the silicon is unidirectionally solidified to give an ingot.

### [Process for Fabricating Polycrystalline Silicon Substrate]

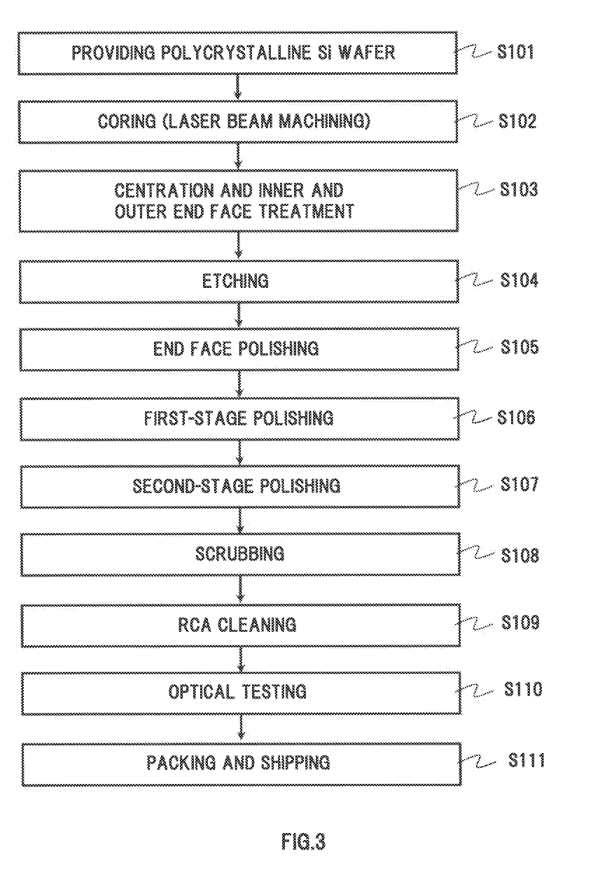

FIG. 3 is a flowchart illustrating an exemplary process for fabricating a polycrystalline Si substrate for magnetic recording media according to the present invention. First, a polycrystalline Si wafer is provided from which a Si substrate is to be obtained by coring (step S101). The polycrystalline Si wafer is obtained by cutting a silicon ingot produced in the above-described manner to a predetermined thickness by means of a wire saw or the like.

After having adjusted the thickness of the polycrystalline Si wafer by lapping, the polycrystalline Si substrate is cored from the polycrystalline Si wafer (step S102). The diameter of the Si substrate thus cored is not more than about 65 mm and not less than about 21 mm. The coring can be achieved by various methods including cutting using a straight cup diamond wheel, ultrasonic cutting, blasting, water jet cutting, and solid-state laser cutting. Laser coring using a solid-state laser is desirable because such laser coring has advantages including: a certain cutting speed ensured, the width of cut reduced, easy change of diameter, and ease of jig making and post-processing. Since such a solid-state laser has a high power density and can reduce the beam diameter, a cut surface obtained by the solid-state laser is relatively clear with less dross. Laser light sources for use in such laser coring include Nd-YAG laser, Yb-YAG laser, and the like.

The Si substrate thus obtained by coring is subjected to centration and inner and outer end face treatment (step S103). Further, the Si substrate is subjected to etching to remove a layer damaged by machining (step S104) and then subjected to end face polishing so as to prevent chipping and the like from occurring during later polishing (step S105).

The Si substrate thus obtained is subjected to polishing so as to have a planarized surface (steps S106 and S107). Generally, the surface of a single crystal Si substrate is smoothed by a multi-stage CMP process using a slurry comprising colloidal silica or the like.

However, common polycrystalline silicon has random crystal orientations crystal grain by crystal grain. For this reason, if the CMP process is carried out on a polycrystalline Si substrate under the same condition as with the single crystal Si substrate, it is difficult to achieve a satisfactory surface smoothness because of the polish rate differing crystal grain by crystal grain.

As described above, besides the {100} faces and {111} faces, low index faces, such as {110} faces and {112} faces, appear on a polycrystalline silicon substrate surface. The polish rates of such faces are different from each other. For this reason, it is difficult to render the polycrystalline silicon substrate surface smooth by polishing under the conventional multi-stage CMP conditions. In this respect, it is preferable to suppress formation of “steps” on the polished surface due to the crystal face index dependence of polish rate by limiting the “chemical action” of the CMP process. For example, a multi-stage CMP treatment (including two or more treatments with abrasive particles changed) is carried out with the pH of the CMP slurry adjusted to a value of not less than 4 and not more than 9.

A finding has been obtained that the smoothness of a polished surface can be improved by adding an oxidizing agent, such as hydrogen peroxide (H₂O₂) or persulfate, as a masking agent to limit the “chemical action” of CMP and suppress differences in polish rate among crystal faces. It is supposed that such a phenomenon occurs because the masking agent forms a thin oxide film over the substrate surface during polishing, which acts to relatively lessen the differences in polish rate among crystal grains of polycrystalline silicon.

The abrasive material used in the form of slurry for such polishing is preferably colloidal silica, which suitably has an average particle diameter of 5 to 80 nm. Preferably, the first-stage polishing (step S106) is performed at a polishing pressure of 5 to 20 kg/cm² while the second-stage polishing (step S107) and later-stage polishing are performed at a polishing pressure of 1 to 10 kg/cm².

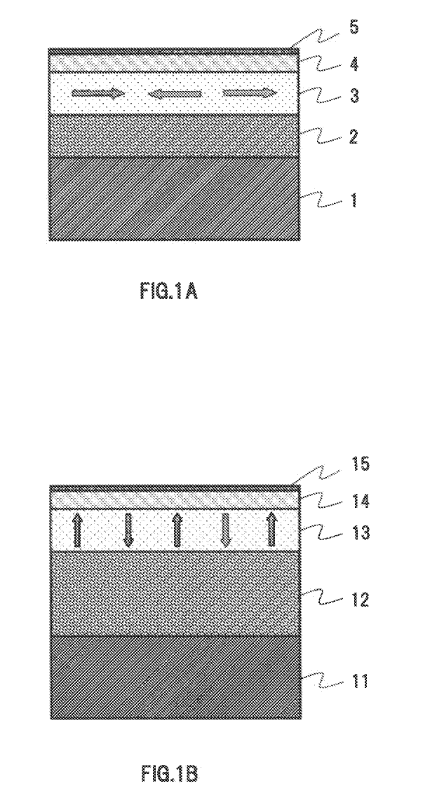

Subsequent to the polishing step (S107), scrubbing (step S108) and RCA cleaning (step S109) are performed to clean the substrate surface. Thereafter, the substrate surface is subjected to optical testing (step S110), and then the Si substrate is packed and shipped (step S111). By sequentially stacking a soft magnetic backing layer, a magnetic recording layer and the like on the thus obtained polycrystalline Si substrate, a magnetic recording medium having a stacked layer structure as shown in FIG. 1B can be obtained. It is possible that an oxide film is formed over the polycrystalline Si substrate described above prior to the formation of the magnetic recording layer and then the magnetic recording layer is formed on the oxide film. This arrangement will be described later.

The polycrystalline Si substrate thus obtained has a mean square waviness value and a mean square microwaviness value which are both not more than 0.3 nm. Thus, the polycrystalline Si substrate has adequate surface properties for a hard disk substrate. With respect to the surface properties, the waviness and the microwaviness of the substrate surface were measured using Opti-Flat manufactured by Phase Shifter Co. and an optical measuring instrument manufactured by Zygo Co., respectively, while the smoothness (i.e., roughness) of the substrate surface was measured using an AFM device manufactured by Digital Instrument Co. By stacking a soft magnetic material and a recording material on such a polycrystalline Si substrate by plating or sputtering, a magnetic recording medium is formed.

[Polycrystalline Silicon Substrate Formed with Oxide Film]

According to the findings obtained from studies made by the inventors of the present invention, the smoothness of a polished surface can be improved by adding 0.1 to 10 mass % of an oxidizing agent, such as hydrogen peroxide (H₂O₂), persulfuric acid, or persulfate, as a masking agent to the CMP slurry used in the above-described polishing. It is supposed that such a phenomenon occurs because the masking agent forms a thin oxide film over the substrate surface during polishing, which acts to relatively lessen the differences in polish rate among crystal grains of polycrystalline silicon. Therefore, intentional provision of an oxide film over a polycrystalline Si substrate surface having appropriately controlled crystal face orientations as described above is considered effective in obtaining a planar and smooth substrate surface.

That is, a mode including: forming an oxide film (having a thickness of not less than 100 nm for example) over a polycrystalline Si substrate surface prior to the polishing step; and subjecting the oxide film to a CMP treatment (two-stage polishing) using a slurry with its pH adjusted to a value of not less than 7 and not more than 11, to obtain a polycrystalline Si substrate formed with a planar and smooth oxide film, is also an effective approach to obtain a planar and smooth polycrystalline Si substrate. A mode including an oxide film formation step additionally provided, for example, between the first-stage polishing (step S106) and the second-stage polishing (step S107) shown in FIG. 3, is a possible approach. In such a case, the thickness of the oxide film after having been polished is set not less than 10 nm and not more than 2,000 nm for example, taking the formation of a film comprising a magnetic material on the oxide film into consideration.

The formation of such an oxide film brings another advantage that the substrate, as a whole, can have improved strength and impact resistance because the strength of the thin substrate can be enhanced by the SiO₂ film formed thereon and because the SiO₂ film, which is amorphous, fails to cleave in a specific direction.

Several methods of forming such an oxide film are conceivable. The following three methods are considered appropriate in view of their economic merits and the like. The first method includes a heat treatment of the polycrystalline Si substrate at 800° C. to 1,200° C. in the atmosphere, or a water vapor or oxidizing atmosphere to form a thermal oxide film. The second method includes coating the polycrystalline Si substrate surface with a silicone material or organosilica and then subjecting the resulting coat to a heat treatment to form an oxide film. The third method includes vapor deposition such as sputtering or the like.

Of these methods, the second method has an advantage that a smooth thin film can be easily obtained by such a method as spin coating and an oxide film can be obtained by heat-treating the thin film at an appropriate temperature to evaporate off the organic components thereof. Specifically, a liquid material containing a silicone material or organosilca is applied to the polycrystalline Si substrate surface to form a smooth thin film, which is then subjected to a heat treatment at an appropriate temperature to allow organic components thereof to evaporate off, thus giving an SiO₂ film.

Examples of materials for use in the oxide film formation by such an approach include a hydrolytic condensate (for example, AQUFLOW T-27 produced by Honeywell Co., AQUGLASS P-5S produced by ALLIED SIGNAL CO., or the like) prepared by hydrolyzing and condensing a silane compound (particularly alkoxysilane). A liquid material comprising such an oxide film forming material is applied to a thickness of not less than 100 nm uniformly in the plane of the substrate surface by spin coating and then the solvent contained therein is allowed to evaporate off at a temperature from 50° C. to not higher than 200° C. in the atmosphere. Subsequently, the resulting coat is subjected to a heat treatment (for 0.1 to 6 hr) at a temperature of not lower than 200° C. and not higher than 800° C. in the atmosphere or an inert gas atmosphere, to give an SiO₂ film or an organic silica film.

Though depending on the kind of silicone material or organosilica used or on the spin coating conditions, the thickness of the oxide film thus formed is not less than about 100 nm and not more than about 2,000 nm. In the case of the mode in which the oxide film formation step is provided between the first-stage polishing (step S106) and the second-stage polishing (step S107) shown in FIG. 3, since the method employed includes coating with the liquid material, spin coating with the liquid material can provide a planar coat which covers steps and grain boundary portions left on the Si substrate surface as long as the Si substrate surface having been subjected to the first-step polishing (step S106) has a certain degree of planarity or higher (for example, steps formed between grains each measure not more than 10 nm and the waviness Wa is not more than about 2.0 nm).

Hereinafter, the present invention will be described by way of examples, which in no way limit the present invention.

### EXAMPLES

Seven types of polycrystalline Si slugs were provided which were different in crystal purity and in contained impurity (i.e., dopant) from each other. Polycrystalline Si slugs of each type as raw material were put into a quartz glass crucible having a diameter of 180 mm provided in a melting furnace. With the crucible held at about 1,420° C. in an inert atmosphere, a melt of silicon was solidified at a rate of not less than 0.01 mm/min and less than 2 mm/min, to give a polycrystalline silicon ingot. Table 1 shows growth conditions for respective ingots as Examples 1 to 6 and Comparative Example 1.

TABLE 1

| | Si purity | | Resistance | Solidification |
|---|---|---|---|---|
| Samples | (%) | Impurity | (Ω cm) | rate (mm/min) |
| Ex. 1 | 99.999 | B | 2 | 0.01 |
| Ex. 2 | 99.99 | P | 0.5 | 0.1 |
| Ex. 3 | 99.99 | Ge | 10 | 1 |
| Ex. 4 | 99.999 | B | 3 | 0.1 |
| Ex. 5 | 99.99 | B | 20 | 0.1 |
| Ex. 6 | 99.99 | B | 10 | 0.1 |
| Com. | 100 | B | 1 | 5 |
| Ex. 1 | | | | |

The polycrystalline silicon ingots thus obtained were each cut and lapped to give polycrystalline Si wafers (step S101). Thereafter, six polycrystalline Si substrates were obtained for each growth condition by coring each polycrystalline substrate having an outer diameter of 60 mm and an inner diameter of 20 mm by using a laser beam machine (YAG laser, wavelength: 1,064 nm) (step S102).

These polycrystalline Si substrates were subjected to centration and inner and outer end face treatment (step S103), etching (step S104), and end face polishing (step S105). Subsequently, the major surface of each polycrystalline Si substrate was subjected to the first-stage polishing (step S106). The first-stage polishing was performed on six substrates per operation for 20 minutes using a double-side polishing machine with a slurry of colloidal silica of pH 8 (average particle diameter: 30 nm), to ensure a surface planarity. Steps formed between grains after the polishing generally measured about 2 nm according to measurement by an optical testing instrument (Zygo Co.). The proportions of crystal face orientations in the plane of the substrate surface were measured by the EPMA-EBSP method (see Table 2).

TABLE 2
SUBSTRATE PROPERTIES

| | Crystal orientations | | | | Film | | | |
|---|---|---|---|---|---|---|---|---|
| Sam- | (percentage: %) | | | Oxide | thickness | Ra | Wa | μwa |
| ples | {100} | {111} | Others | film | (nm) | (nm) | (nm) | (nm) |
| Ex. 1 | 40 | 50 | 10 | — | — | 0.20 | 0.21 | 0.23 |
| Ex. 2 | 35 | 35 | 30 | — | — | 0.24 | 0.25 | 0.28 |
| Ex. 3 | 45 | 20 | 35 | — | — | 0.25 | 0.28 | 0.28 |
| Ex. 4 | 40 | 40 | 20 | Sio₂ | 1000 | 0.08 | 0.12 | 0.11 |
| Ex. 5 | 30 | 30 | 40 | Organic | 500 | 0.15 | 0.17 | 0.18 |
| | | | | sio₂ | | | | |
| Ex. 6 | 35 | 35 | 30 | Organic | 2000 | 0.12 | 0.15 | 0.16 |
| | | | | sio₂ | | | | |
| Com. | 65 | 20 | 15 | — | — | 5.0 | 3.7 | 3.9 |
| Ex. 1 | | | | | | | | |

Regarding the samples of Examples 1 to 3, each substrate was subjected to scrubbing after the first-stage polishing and then to the second-stage polishing for 20 minutes using fine particle colloidal silica for finishing (pH value: 8, particle diameter: 15 nm) (step S107), to give a smooth polished surface with no minute defect.

Regarding the sample of Example 4, each substrate was subjected to scrubbing after the first-stage polishing and then to thermal oxidation treatment at 1,000° C. for one hour in the atmosphere with air flowing at a flow rate of 1 liter/hr. The oxide film thus formed was 1,000 nm thick according to measurement by an ellipsometer. The oxide film surface of the polycrystalline Si substrate formed with the oxide film was subjected to the second-stage polishing for 20 minutes using fine particle colloidal silica for finishing (pH value: 10, particle diameter: 15 nm) (step S107), to give a smooth polished surface with no minute defect.

Regarding the sample of Example 5, each substrate was subjected to scrubbing after the first-stage polishing and then coated with organosilica (T-2-Si-58000-SG produced by TOKYO OHKA KOGYO CO., LTD.) by a spin coater. The substrate was heated at 400° C. for 30 minutes in the atmosphere, to form an oxide film. According to measurement by a film thickness tester, the oxide film had a thickness of about 500 nm and exhibited a uniform thickness distribution in the plane of the substrate surface. The oxide film surface of the polycrystalline Si substrate thus formed with the oxide film was subjected to the second-stage polishing for 20 minutes using fine particle colloidal silica for finishing (pH value: 10, particle diameter: 15 nm) (step S107), to give a smooth polished surface with no minute defect.

Regarding the sample of Example 6, each substrate was subjected to scrubbing after the first-stage polishing and then coated with organosilica (AQUFLOW T-27 produced by Honeywell Co.) by a spin coater. The substrate was heated at 250° C. for 30 minutes in the atmosphere, to form an oxide film. According to measurement by the film thickness tester, the oxide film had a thickness of about 2,000 nm and exhibited a uniform thickness distribution in the plane of the substrate surface. The oxide film surface of the polycrystalline Si substrate thus formed with the oxide film was subjected to the second-stage polishing for 20 minutes using fine particle colloidal silica for finishing (pH value: 10, particle diameter: 15 nm) (step S107), to give a smooth polished surface with no minute defect.

These polycrystalline Si substrates of Examples 1 to 6 were each subjected to scrubbing (step S108) to remove residual colloidal silica and then to precision cleaning (i.e., RCA cleaning: step S109). The waviness and the microwaviness of the polished surface of each substrate were measured using Opti-Flat manufactured by Phase Shifter Co. and an optical measuring instrument manufactured by Zygo Co., respectively, while the smoothness (i.e., roughness) of the polished surface was measured by an AFM apparatus manufactured by Digital Instrument Co. (step S110).

Table 2 collectively shows the results of evaluation thus obtained (Ra: roughness, Wa: waviness, and μ-Wa: microwaviness). As can be seen from these results, each of the polycrystalline Si substrates according to the examples of the present invention had good surface properties, and any step formed due to differences in crystal face orientation among crystal grains was not observed.

Regarding the sample of Comparative Example 1, polycrystalline Si slugs having a purity of 99.999% were put into a quartz glass crucible having a diameter of 100 mm provided in a melting furnace and then melted at about 1,500° C. in a vacuum. The melt of silicon was unidirectionally solidified at a solidification rate of 5 mm/min, to give a silicon ingot. The proportions of crystal face orientations in the plane of the polycrystalline Si substrate were measured by the EPMA-EBSP method as in the examples (see Tables 1 and 2).

Though the process for fabricating substrates from the ingot was substantially the same as in the above-described examples, the substrate surface of each substrate was polished for 20 minutes using fine particle colloidal silica for finishing (pH value: 10, particle diameter: 15 nm) in the second-stage polishing. Oxide film formation on the substrate surface was not carried out.

As can be seen from the results of evaluation shown in Table 2, any one of the roughness, waviness and microwaviness of the sample of Comparative Example 1 show a value which is higher by one order of magnitude or more than that of the sample of each example. As can be confirmed from these results, the polycrystalline Si substrate according to the present invention has very good surface properties. Also, the properties of polycrystalline Si as the material of the substrate can assure that the substrate has sufficient impact resistance and heat resistance and fails to complicate the fabrication process and the film formation process for a magnetic recording layer. Further, the polycrystalline Si substrate can be utilized as a polycrystalline Si substrate for magnetic recording media which has such an excellent surface planarity as to allow a low flying height to be realized and is inexpensive.

A soft magnetic backing layer and a magnetic recording layer were formed on each of the substrates obtained in Examples 1 and 4 and Comparative Example 1 by sputtering. The film arrangement is C (6 nm)/CoPtTiO₂ (15 nm)/Ru (30 nm)/Pt (10 nm)/CoZrNb-SUL (200 nm)/substrate in the descending order. The device used to measure magnetic properties is a spinstand manufactured by Kyodo Denshi Co, and a magnetic monopole head (manufactured by ALPS CO.) is used as a recording head. The measurement conditions are: revolving speed=4,200 rpm, measurement radius R=25 mm, relative linear velocity of head and medium=11.0 m/s, and recording/erasing current=50 mA.

Each magnetic recording medium having the above-described structure was set on the spinstand and subjected to DC erasing. Thereafter, writing was performed on each magnetic recording medium by a nano-spacing slider head flying at a flying height of 10 nm. According to the results of measurement of reproduction signals, the recording media fabricated using the substrates of Examples 1 and 4 exhibited an average S/N ratio of 30 dB at 20 Hz, whereas the recording medium fabricated using the substrate of Comparative Example 1 did not allow proper measurement because of generation of head collision signals due to unevenness of the substrate. As can be seen from these results, the polycrystalline silicon substrate according to the present invention is smooth and a magnetic recording medium fabricated using the polycrystalline silicon substrate produces low noise in a low-frequency region.

According to the present invention, a polycrystalline Si substrate for magnetic recording media is provided which has sufficient impact resistance and heat resistance, fails to complicate the fabrication process and the film formation process for a magnetic recording layer, has such an excellent surface planarity as to allow a low flying height to be realized, and is inexpensive.

What is claimed is:

1. A polycrystalline silicon substrate for magnetic recording media, comprising a substrate surface, and {100} crystal faces included in the substrate surface, wherein a proportion of a total area (S_{{100}}) of the {100} crystal faces to a total area (S₀) of the substrate surface is not less than 10% and is less than 50%.

2. The polycrystalline silicon substrate for magnetic recording media according to claim 1, further comprising an oxide film having a thickness of not less than 10 nm and not more than 2,000 nm and formed over the surface of the polycrystalline silicon substrate.

3. The polycrystalline silicon substrate for magnetic recording media according to claim 1, which has a mean square waviness value and a mean square microwaviness value which are both not more than 0.3 nm.

4. The polycrystalline silicon substrate for magnetic recording media according to claim 1, which is cut out of an ingot grown by unidirectional solidification at a solidification rate of not less than 0.01 mm/min and not more than 1 mm/min.

5. A magnetic recording medium comprising the polycrystalline silicon substrate according to claim 1, and a magnetic recording layer formed thereon.

6. The polycrystalline silicon substrate for magnetic recording media according to claim 2, which has a mean square waviness value and a mean square microwaviness value which are both not more than 0.3 nm.

7. The polycrystalline silicon substrate for magnetic recording media according to claim 2, which is cut out of an ingot grown by unidirectional solidification at a solidification rate of not less than 0.01 mm/min and not more than 1 mm/min.

8. A magnetic recording medium comprising the polycrystalline silicon substrate according to claim 2, and a magnetic recording layer formed thereon.

9. The polycrystalline silicon substrate for magnetic recording media according to claim 3, which is cut out of an ingot grown by unidirectional solidification at a solidification rate of not less than 0.01 mm/min and not more than 1 mm/min.

10. A magnetic recording medium comprising the polycrystalline silicon substrate according to claim 3, and a magnetic recording layer formed thereon.

11. A polycrystalline silicon substrate for magnetic recording media, comprising a substrate surface, and {111} crystal faces included in the substrate surface, wherein a proportion of a total area (S_{{111}}) of the {111} crystal faces to a total area (S₀) of the substrate surface is not less than 30% and not more than 90%.

12. The polycrystalline silicon substrate for magnetic recording media according to claim 11, further comprising an oxide film having a thickness of not less than 10 nm and not more than 2,000 nm and formed over the surface of the polycrystalline silicon substrate.

13. The polycrystalline silicon substrate for magnetic recording media according to claim 11, which has a mean square waviness value and a mean square microwaviness value which are both not more than 0.3 nm.

14. The polycrystalline silicon substrate for magnetic recording media according to claim 11, which is cut out of an ingot grown by unidirectional solidification at a solidification rate of not less than 0.01 mm/min and not more than 1 mm/min.

15. A magnetic recording medium comprising the polycrystalline silicon substrate according to claim 11, and a magnetic recording layer formed thereon.

16. The polycrystalline silicon substrate for magnetic recording media according to claim 12, which has a mean square waviness value and a mean square microwaviness value which are both not more than 0.3 nm.

17. The polycrystalline silicon substrate for magnetic recording media according to claim 12, which is cut out of an ingot grown by unidirectional solidification at a solidification rate of not less than 0.01 mm/min and not more than 1 mm/min.

18. A magnetic recording medium comprising the polycrystalline silicon substrate according to claim 12, and a magnetic recording layer formed thereon.

19. The polycrystalline silicon substrate for magnetic recording media according to claim 13, which is cut out of an ingot grown by unidirectional solidification at a solidification rate of not less than 0.01 mm/min and not more than 1 mm/min.

20. A magnetic recording medium comprising the polycrystalline silicon substrate according to claim 13, and a magnetic recording layer formed thereon.
